(19) United States
(12) Patent Application Publication
(10) Pub. No.: US 2005/0288995 A1
(43) Pub. Date: Dec. 29, 2005

(54) Method for evaluating interactive corporate systems

(75) Inventors: Lisa A. Kennedy, Appleton, WI (US); James R. Smits, De Pere, WI (US); Eric F. Wagner, Sherwood, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/877,052

(22) Filed: Jun. 25, 2004

(51) Int. Cl. G06Q 10/00

(52) U.S. Cl. 705/11

(57) ABSTRACT

A method for evaluating the performance of an interactive corporate system includes the steps of identifying a plurality of system implementation activities that concern system interaction from more than one input source or interactive entity, providing a predefined rating definition for each of a plurality of possible ratings for each of the implementation activities, and selecting one of the possible ratings for each of the plurality of implementation activities based on select consideration of the predefined rating definitions for each implementation activity. In some embodiments, the interactive corporate system may correspond to an Employee Assistance Program (EAP).

### BACKGROUND OF THE INVENTION

As individuals strive to balance an increasing daily load of both personal and professional obligations, many employers have become more sensitive to the needs and well-being of their employees. Some employers have begun offering personal assistance services to their employees in an attempt to increase productivity, retain employees, decrease absenteeism, and improve the general health and morale of employees. More specifically, some employers now offer personal assistance services to their employees that are referred to as Employee Assistance Programs (EAPs). Conventional EAPs may be utilized by an employee to assist with addressing a variety of personal and/or work-related concerns that may potentially be encountered in daily life and that run the risk of adversely impacting work performance, conduct, health and general well-being. Examples of such concerns include, but are not limited to, family care, health care, retirement, benefits, education, relocation, financial planning or problems, marital concerns, work concerns, family issues, alcohol or drug problems, legal advice, stress, and emotional issues.

EAPs have recently proven to be useful corporate tools that have a positive impact on the health and performance of employees and that also contribute to the overall organizational strength of a corporation. As with any valuable resource, a desire exists to monitor and evaluate the performance of EAP systems such that appropriate system characterizations may be made and system improvements may be realized when needed.

Some known features for evaluating the effectiveness of an EAP or similar system rely heavily on a calculated percentage of employee utilization. However, knowledge of the number of employees that utilize an EAP relays little information about the actual effectiveness of such systems. Furthermore, known EAP evaluation mechanisms typically allow for input only from the actual EAP vendor, and not from corporate management groups that solicit EAP services, nor from employees that utilize them.

As such, a need currently exists for a readily accessible and effective method to evaluate and improve EAPs and other corporate systems, whereby evaluation inputs are received on a variety of levels and with increased capabilities for monitoring and refinement.

### SUMMARY OF THE INVENTION

Objects and advantages of the invention will be set forth in part in the following description, or may be obvious from the description, or may be learned through practice of the invention.

In general, the present invention is directed to a method for evaluating the effective performance of an interactive human resource system such as, but not limited to, the performance of an Employee Assistance Program (EAP). Other human resource applications may include systems related to health and wellness programming, labor relation, performance management, diversity programs, recruiting efforts, etc. Features may be provided for an ongoing or periodic status review of selected essential elements and corresponding implementation activities for a fully operational interactive human resource system, as well as for continuous improvement and/or updating of such a system.

One advantage in accordance with certain embodiments of the invention is that system aspects may be evaluated from the perspective of multiple interactive entities. Multiple entities may include, for example, employees, a system vendor, and corporate management. Data input may also be received from multiple such inputs in the evaluation process to allow a more detailed analysis and to provide more parameters for subsequent benchmarking.

Another advantage in accordance with certain embodiments of the invention is that the evaluation may be provided with a generally user-friendly interface, such as an automated spreadsheet that stores the information in a networked database accessible by selected users on the facility or corporate level. Providing access of the evaluation data to a variety of users facilitates subsequent analysis and utilization of evaluation results.

One embodiment of the present invention corresponds to a method for evaluating the performance of an interactive human resource system. A first step in such a method corresponds to identifying a plurality of system implementation activities that may concern system interaction from more than one input source, or interactive entity (e.g., a vendor of the interactive human resource system, selected management personnel of the corporation utilizing the interactive human resource system, and selected employees who have interacted with the human resource system). Exemplary implementation activities may be identified based on core elements of a corporate policy.

In a subsequent step, a predefined rating definition may be provided for each of a plurality of possible ratings for each implementation activity. In some embodiments, possible ratings are provided on incremental levels of potential system effectiveness.

A still further step concerns selecting one of the possible ratings for each of the plurality of implementation activities. This selection may be based on select consideration of the predefined rating definitions for each implementation activity. Rating selection may further correspond to establishing that the predefined rating definition corresponding to the selected rating has been satisfied for a predetermined minimum amount of time. Exemplary steps for establishing such rating definition satisfaction may include one or more of the following steps: determining what activities and tasks are being performed that demonstrate process step(s) have been implemented that meet the intent of the predefined rating definition, identifying a responsible entity for the implementation activity, determining how often aspects of the predefined rating definition corresponding to a given implementation activity are completed or updated, and providing or locating documentation to support the selected rating and predefined definition for a given implementation activity.

Still further steps associated with the subject methodology may selectively include entering selected ratings for each implementation activity in a networked database, identifying based on the selected ratings one or more implementation activities for which rating improvement is desired, and taking subsequent steps within a given corporation or specific facility thereof to improve ratings of selected implementation activities identified for desired improvement.

Other features and aspects of the present invention are discussed in greater detail below.

### BRIEF DESCRIPTION OF THE DRAWING

FIG. 1 provides a block diagram illustration of exemplary steps in one embodiment of a method for evaluating the performance of an interactive corporate system in accordance with the present invention; and

FIG. 2 provides a block diagram illustration of exemplary steps related to a process of selecting possible ratings in accordance with a method for evaluating performance of an interactive corporate system in accordance with the present invention.

### DETAILED DESCRIPTION OF THE INVENTION

The invention will now be described in detail with reference to particular embodiments thereof. The embodiments are provided by way of explanation of the invention, and are not meant as a limitation of the invention. It will be apparent to those skilled in the art that various modifications and variations can be made in the present invention without departing from the scope and spirit of the invention. For example, features described or illustrated as part of one embodiment may be used with another embodiment to yield a still further embodiment. Thus, it is intended that the present invention include these and other modifications and variations as come within the scope and spirit of the invention, including the appended claims and their equivalents.

The present invention is directed to providing features for measuring and evaluating the effectiveness of an interactive human resource system, as well as providing features for improvement to such systems. Although not limited to this example, one embodiment of such an interactive corporate system that may utilize features of the subject invention concerns an Employee Assistance Program (EAP). Exemplary aspects of the present invention may be hereafter presented with regard to EAP evaluation systems, but it should be appreciated that the present invention may also be extended to such interactive human resource systems as those relating to health and wellness programming, labor relations and coordination, performance management, benefits coordination, health/life insurance, diversity programs, recruiting efforts, etc.

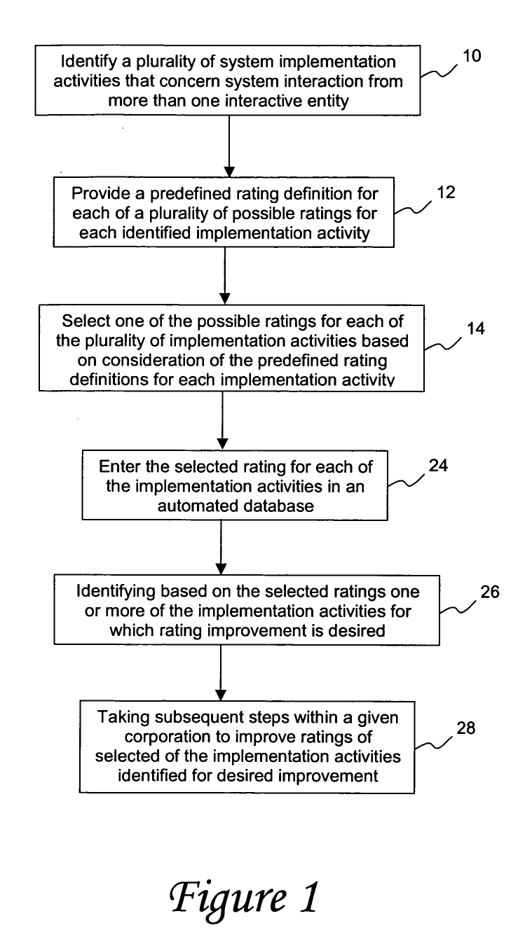

Referring now to the drawings, FIG. 1 provides a block diagram illustration of an exemplary method of measuring and/or evaluating the effective performance of an interactive human resource system, such as an EAP. A first step 10 in such an exemplary method corresponds to identifying a plurality of system implementation activities. System implementation activities in accordance with certain embodiments may correspond to activities that are desirable for implementation.

One important characteristic of such implementation activities, especially in the realm of EAP evaluation, is that the activities address implementation of the interactive corporate system from the perspective of more than one entity that interacts with the system. For example, in an EAP evaluation system, the implementation activities are concerned with how the EAP is implemented from the perspective of an EAP vendor (i.e., the entity that provides EAP services to a given corporation), the employees (i.e., those who typically utilize the products and/or services provided by the EAP vendor), and management personnel from the corporation utilizing the EAP products and/or services.

A large amount of variety is afforded to the specific number and type of implementation activities identified in exemplary step 10 of FIG. 1. Many times the determination of implementation activities is influenced by core elements of corporate policy for a given corporation. Such core elements help to characterize some of the overall groupings that multiple implementation activities could be considered a part of. For example, in one embodiment core elements of a corporate policy might include such generally broad categories as management, leadership and commitment, EAP awareness and operating guidelines. Examples of implementation activities in a category generally concerning management, leadership and commitment may relate to (without limitation) an EAP mission statement, actions taken by EAP service providers, actions taken by an EAP/Wellness Committee, EAP objectives for a given corporate facility, labor/management activities, labor/management training, and EAP system evaluation.

Tables 1 and 2 below are intended to include the above examples of implementation activities relating generally to management, leadership and commitment aspects of a corporate EAP system, and are provided by way of example only. Additional details regarding such exemplary implementation activities and the corresponding rating information also provided in Tables 1 and 2 will be discussed later in further detail.

TABLE 1
IMPLEMENTATION ACTIVITES (I.A.s) AND RATINGS FOR
MANAGEMENT, LEADERSHIP AND COMMITMENT ISSUES

| | I.A. | | |
|---|---|---|---|
| Rating | EAP Statement | EAP Service Providers | EAP/Wellness Committee |
| 5 | The EAP statement is | EAP providers influence | The EAP/Wellness |
| | integrated into | business decisions by | committee partners with the |
| | business planning | providing consultation, | leadership team on past |
| | activities by | resources and information. | results and proposed future |
| | recognizing health and | | activities. |
| | well-being as | | |
| | fundamental values. | | |
| 4 | The EAP statement is | EAP providers are | The EAP/Wellness |
| | communicated to all | recognized as competent | committee is active in |
| | employees through a | internal resources and | utilization analysis and |
| | variety of formats. | understand EAP roles and | needs identification along |
| | | boundaries. | with implementation of |
| | | | identified site specific |
| | | | program activities. |
| 3 | An EAP statement has | EAP providers have | The committee members |
| | been developed to be | received training in | represent all functional units |
| | specific to the facility | company policies, | in the facility and include all |
| | and proactively outlines | practices, culture and site | levels of the organization. |
| | the activities required | history. | Regular meetings are held |
| | to implement the | | with a planned agenda and |
| | Corporate EAP | | members plan and promote |
| | statement. | | activities. |
| 2 | The current facility | Specific EAP vendor | The EAP/Wellness |
| | management reviews | expectations and | Committee is mainly a |
| | and endorses the | accountabilities have been | mechanism for education |
| | statement on a periodic | developed and agreed to. | and awareness. |
| | basis. | | |
| 1 | The facility | EAP providers have been | An EAP/Wellness |
| | EAP/Wellness | identified and a vendor | committee has been |
| | statement supports the | contract is in place. | established and members |
| | Corporate statement. | | have been assigned. The |
| | | | committee meets as |
| | | | needed. |

TABLE 2
IMPLEMENTATION ACTIVITES (I.A.s) AND RATINGS FOR
MANAGEMENT, LEADERSHIP AND COMMITMENT ISSUES

| | I.A. | | | |
|---|---|---|---|---|
| | Facility EAP | Labor/Management | Labor/Management | EAP System |
| Rating | Objectives | Activities | Training | Evaluation |
| 5 | The facility's | Management | Managers and | An independent |
| | objectives include | incorporates EAP | labor leaders | auditor works with |
| | EAP activities to | activities into daily | collaborate with | the EAP |
| | support business | operations to | EAP to design | committee, vendor |
| | operations. | ensure people and | programs to | and site |
| | Achievements | performance | address the people | labor/management |
| | are recognized | problems are | side of | to conduct an audit |
| | and rewarded. | effectively resolved. | organizational | of EAP |
| | | | issues. | performance. |
| 4 | Facility objectives | Managers and | Managers and | EAP committee |
| | for EAP have | labor leaders are | labor leaders | and vendor meet |
| | been developed | measured on their | participate in | with the site |
| | and progress is | EAP support. | biannual EAP | labor/management |
| | measured, | | educational forums. | representatives to |
| | recognized and | | | conduct an annual |
| | rewarded. | | | audit of EAP |
| | | | | performance. |
| 3 | Periodic surveys | Managers and | Managers and | EAP committee |
| | of employee | labor leaders | labor leaders | and vendor conduct |
| | attitude and | participate in EAP | participate in | an annual audit of |
| | awareness | promotions and | regular training to | EAP activities and |
| | toward EAP are | encourage | identify and | progress towards |
| | conducted. | utilization. | address | objectives. |
| | | | performance | |
| | | | problems. | |
| 2 | Annual objectives | Managers and | Managers and | EAP committee |
| | related to EAP | labor leaders | labor leaders | conducts an annual |
| | utilization are | understand and | preview EAP | review of progress |
| | established and | support EAP | programs designed | towards objectives. |
| | progress is | services. | to address critical | |
| | measured. | | relationship issues | |
| | | | affecting teams. | |
| 1 | Utilization rates | Managers and | Managers and | EAP committee |
| | are documented | labor leaders are | labor leaders | conducts a review |
| | quarterly as | aware of EAP and | receive an annual | of programs and |
| | required by | the services. | orientation on EAP | activities. |
| | company | | services. | |
| | standards and | | | |
| | forwarded to | | | |
| | Corporate EAP | | | |
| | and site location. | | | |

Examples of implementation activities in a category generally concerning EAP awareness may relate to (without limitation) employee roles and responsibilities, training activities, and promotions consideration. Table 3 below is intended to include the above examples of implementation activities relating generally to EAP Awareness aspects of a corporate EAP system, and is provided by way of example only. Additional details regarding such exemplary implementation activities and the corresponding rating information also provided in Table 3 will be discussed later in further detail.

TABLE 3
IMPLEMENTATION ACTIVITIES (I.A.s) AND RATINGS FOR EAP
AWARENESS ISSUES

| | I.A. | | |
|---|---|---|---|
| | Employee Roles and | | |
| Rating | Responsibilties | Training | Promotion |
| 5 | Employees are involved | Leaders and employees are | A system is in place to |
| | in a process identifying | involved in training other | ensure the management |
| | opportunities for | employees and family | team annually reviews the |
| | improving involvement | about EAP and its impact. | EAP promotions plan. |
| | in EAP and developing | | |
| | EAP objectives. | | |
| 4 | All employees and | EAP is incorporated into | The EAP promotion plan |
| | leaders have been | regular training programs. | has been integrated into all |
| | trained in identifying | | aspects of the business |
| | signs and symptoms in | | that impact employees. |
| | co-workers. | | |
| 3 | Employees participate | Leaders and union | EAP promotions are used |
| | in EAP committees and | personnel are trained on | to encourage employees to |
| | activities and assist in | EAP objectives, referral | utilize their EAP resources |
| | the development of | procedures, and | and to confront other |
| | programs to educate, | organizational impact. | employees. |
| | raise awareness and | | |
| | promote EAP. | | |
| 2 | Employees provide | Stress, chemical | An EAP promotions plan |
| | input/feedback into EAP | dependency, grief, and | has been implemented |
| | services (surveys, etc.). | other customized education | which includes employee |
| | | presentations are provided | awareness, education and |
| | | to employee groups on a | promotion. |
| | | regular basis. | |
| 1 | All new employees | Information about EAP | Response to EAP issues |
| | participate in an | services, hours, locations, | are primarily reactive and |
| | orientation process that | as well as educational | rely on word of mouth |
| | includes an introduction | materials on important | publicity. |
| | to corporate EAP. | social, family, alcohol/drug | |
| | | mental health issues, etc. | |
| | | are presented upon request | |
| | | to employees. | |

Examples of implementation activities in a category generally concerning operating guidelines may relate to (without limitation) EAP system access, EAP responsiveness, vendor standards and procedures, vendor credentials, and vendor agreement. Tables 4 and 5 below are intended to include the above examples of implementation activities relating generally to operating guideline aspects of a corporate EAP system, and are provided by way of example only. Additional details regarding such exemplary implementation activities and the corresponding rating information also provided in Tables 4 and 5 will be discussed later in further detail.

TABLE 4
IMPLEMENTATION ACTIVITIES (I.A.s) AND RATINGS FOR
OPERATING GUIDELINES ISSUES

| | I.A. | |
|---|---|---|
| Rating | Access | Responsiveness |
| 5 | A system is used to document and | EAP provider is willing to provide onsite |
| | evaluate accessibility of EAP services | services/offices if requested by the business |
| | annually. | unit. |
| 4 | EAP offices ensure confidentiality and | The EAP offers flexible appointment times |
| | are also conveniently located. | based on customer needs and operating |
| | | schedules. |
| 3 | The EAP provides 24-hour a day | Those calls requiring immediate response |
| | access for calls placed after formal | due to potential life-threatening situations are |
| | office hours. EAP provides both local | scheduled for an appointment within a |
| | telephone number and toll free | predetermined minimum amount of time |
| | number. | (e.g., 4 hours). |
| 2 | EAP clients access EAP services | Those calls not requiring immediate |
| | directly or through referrals by the | response/appointment, but requiring |
| | OHN, coworkers, family, supervisors, | attention soon due to seriousness, are |
| | labor personnel or HR professionals. | scheduled within a predetermined amount of |
| | | time from the time of the call (e.g., 36 hours). |
| 1 | EAP clients access services via | Those calls requiring an appointment are |
| | telephone and scheduled | offered a scheduled time within a |
| | appointments. | predetermined amount of time (e.g., 2 days). |

TABLE 5
IMPLEMENTATION ACTIVITIES (I.A.s) AND RATINGS FOR
OPERATING GUIDELINES ISSUES

| | I.A. | | |
|---|---|---|---|
| | Vendor Standards & | | |
| Rating | Procedures | Vendor Credentials | Vendor Agreement |
| 5 | A formal contract with an | EAP provider | The Management Team |
| | EAP or mental health | demonstrates an effective | conducts formal review of |
| | provider is in place for | working relationship with | the vendor agreement |
| | EAP staff to seek | community resources and | including utilization rate and |
| | professional EAP or | key treatment personnel | survey results. |
| | mental health | while implementing and | |
| | service/treatment when | tailoring treatment plans | |
| | needed. | for clients. | |
| 4 | The EAP vendor | EAP provider is | EAP vendors are selected |
| | maintains contact with | recognized for quality | from those whose |
| | client treatment provider | services. | counseling abilities have |
| | and the workplace if | | been identified to be |
| | appropriate to assure | | consistent with the |
| | goals and treatment plan | | organization's selection |
| | are being met. | | criteria. |
| 3 | Receptionist is skilled in | EAP provider has minimal | EAP providers are required |
| | responding to crisis/ | staff turnover. | in their vendor agreements |
| | urgent situations and in | | to include evidence of |
| | identifying intervention | | competency. |
| | needed from consultant. | | |
| 2 | Documentation | EAP providers have | Bid specifications (vendor |
| | procedures and protocols | appropriate education, | agreements) define that the |
| | are used by general office | state and national | vendor coordinates their |
| | and professional EAP | certifications and | work activities with those of |
| | staff. | licensures. EAP provider | the organization. |
| | | provides an effective plan | |
| | | for continuing education | |
| | | of EAP consultants. | |
| 1 | Documented formal | EAP providers have a | There is a system that |
| | standards of professional | formal confidentiality | ensures that the EAP vendor |
| | conduct are adopted and | agreement which meets | capabilities match job |
| | adhered to as a condition | Corporate requirements | requirements. |
| | of provider employment. | and reviews it with each | |
| | | client. | |

It can be observed from the above tables, that it is often desirable to provide a relatively large number of implementation activities. This helps ensure that as many as possible associated features of a given interactive human resource system are evaluated when performing the subject system evaluation. It is equally important to note that the implementation activities also concern system aspects and activities from the perspective of more than one interactive entity, or input source. For example, in an EAP evaluation process, implementation activities address features that affect not only the EAP vendor, but also employees who have or will interact with the EAP system as well as management personnel of the corporation utilizing the EAP system, particularly those who might work with the EAP vendor to implement and/or oversee the EAP system within a given corporation or various facilities thereof.

Part of performance evaluation in accordance with certain embodiments of the present invention involves rating the implementation activities. As such, a variety of different ratings may be provided to choose from. Referring again to FIG. 1, after the plurality of implementation activities are identified in step 10, a subsequent step 12 of providing a predefined rating definition for each of a plurality of different ratings for each implementation activity is effected. In the examples provided in Tables 1-5, respectively, five possible ratings are provided for each implementation activity. These five ratings are indicated in Tables 1-5 as single-digit numeric ratings where effectiveness can be selected on an incremental level with a rating of one (1) being the lowest and a rating of five (5) being the highest. It should be appreciated that the number of different ratings provided for the implementation activities is not limited to five. For example, a greater or fewer number of possible ratings for each implementation activity may be provided, and the number of possible ratings may vary among different implementation activities or selected categories thereof. Furthermore, it should be appreciated that although the possible ratings listed in the examples of Tables 1-5 are designated by single-digit numeric identifiers, ratings may be designated by any particular type of alphanumeric identifier or verbal description. For example, ratings of 5, 4, 3, 2 and 1 may correspond to alphanumeric ratings such as “A”, “B”, “C”, “D” and “F” or to ratings with such verbal descriptions as “world class”, “superior”, “commendable”, “intermediate” and “basic”, respectively.

In further accordance with step 12 of FIG. 1, a predefined rating definition for each possible rating an implementation activity may achieve is provided. Since possible ratings of 1, 2, 3, 4 and 5 are available for each exemplary implementation activity in Tables 1-5, five predefined rating definitions are provided for each implementation activity. A predefined rating definition may describe the activities that are required to be in place for a rating corresponding to that definition to be achieved. For example, consider the first exemplary implementation activity of Table 3, concerning employee roles and responsibilities. In order to achieve the lowest relative rating of “1”, a determination must be made that all new employees participate in an orientation process that includes an introduction to corporate EAP systems. In order to achieve a rating of “2”, a determination must be made that the employees of the given corporation provide input/feedback into EAP services (e.g., via surveys, etc.). To achieve a rating of “3”, it should be determined that employees participate in EAP committees and activities and assist in the development of programs to educate, raise awareness and promote EAP. A rating of “4” is achieved upon determination that all employees and leaders have been trained in identifying signs and symptoms of co-workers, and the highest relative rating of “5” is determined when employees are involved in a process identifying opportunities for improving involvement in EAP and developing EAP objectives. As noted from the rather detailed rating definitions defined for each rating associated with this and other implementation activities, the step of providing such definitions is often quite a significant step. However, once this step is established, the predefined ratings and rating definitions may be used in multiple review processes. For example, the same ratings and corresponding rating definitions can be used for multiple facilities in a given corporation, and/or may also be used for multiple reviews at a given facility (e.g., for reviews completed every 6, 12, 24 months, or in other predetermined time increments).

Referring still to FIG. 1, once all implementation activities, possible ratings and corresponding rating definitions are provided, a next step 14 involves selecting one of the possible ratings for each implementation activity. The selection process may be effected by an assembled group of contributing entities, referred to herein as a review committee. When the subject evaluation process occurs at a given corporate facility for an EAP system, such a review committee may include, for example, the facility site leader, representatives from an EAP committee associated with the facility or with the corporation, and the EAP vendor. An EAP/Wellness committee may be provided for one or more facilities of a corporation to address corporate aspects and concerns with implementation of an EAP system. Additional examples of entities that may be part of a review committee for effecting the subject evaluation procedures include, but are not limited to, personnel from Human Resources, Health Services, and Labor in order to help ensure adequate input from key EAP customers (e.g., corporate employees). Any amount of preparation, such as may be involved in steps 10 and 12 of the process depicted in FIG. 1, may be handled before the selection process of step 14 by designated person(s) such as the EAP Committee chairperson and EAP vendor.

By employing a relatively wide variety of entities in the review committee that selects ratings for each implementation activity, certain advantages are achieved. In such a fashion, not only do the identified implementation activities concern aspects of an EAP system from the perspective of multiple entities (e.g., employees, management, and EAP vendor(s)), but so does the input used in selecting step 14. Known EAP evaluation systems consider data input only from the perspective of the EAP vendor. The evaluation system may consider data input from a plurality of interactive entities, such as from employees, management personnel and from the EAP vendor. This allows for a more detailed evaluation analysis by providing more parameters to measure against.

Referring still to exemplary step 14 of FIG. 1, the step of selecting one rating for each identified implementation activity is based on consideration of the predefined rating definitions provided for each implementation activity. A determination is made identifying the highest predefined rating definition that has been satisfied. It may be required in accordance with some embodiments that a rating definition has been satisfied for a predetermined minimum amount of time (e.g., six months) for a certain rating to be achieved. A variety of steps may be taken in order to more affirmatively establish that a rating definition has been satisfied.

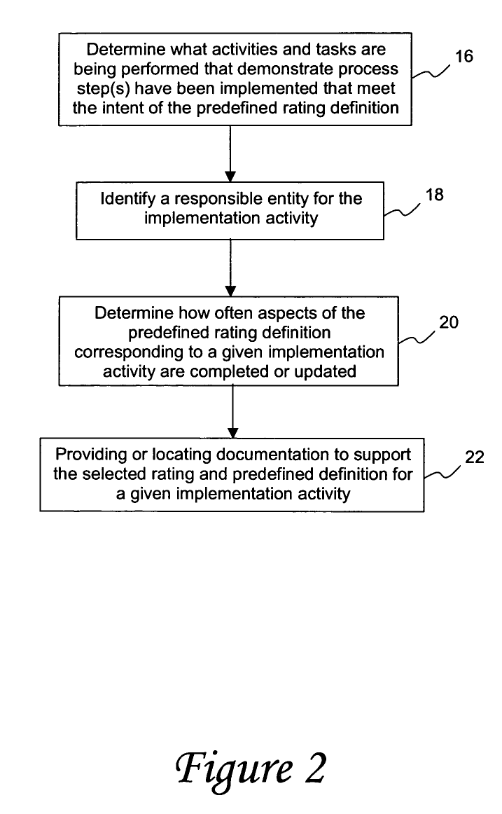

Referring more particularly now to FIG. 2, exemplary steps associated with the step of selecting a rating based on consideration of predefined rating definitions is provided. A first exemplary step 16 in such selecting process is to determine what activities and tasks are being or have been performed that demonstrate process step(s) have been implemented that meet the intent of the predefined rating definition. Another exemplary step 18 corresponds to identifying a responsible entity for the subject implementation activity and associated rating definition(s). A still further step 20 that may be selectively utilized to affirmatively establish that a rating definition has been satisfied is to determine how often aspects of the predefined rating definition corresponding to a given implementation activity are completed or updated. Yet another exemplary step 22 corresponds to providing, locating or describing documentation to support a particular rating definition for a given implementation activity. Documentation in accordance with exemplary step 22 may include such evidence as written standards or procedures defining the activity or task identified in the rating definition.

To relate the above steps to one embodiment of the exemplary implementation activities provided in Tables 1-5, consider the first implementation activity listed in Table 3 concerning “Employee Roles and Responsibilities”. A review committee first considers the lowest possible rating and rating definition (1) —“All new employees participate in an orientation process that includes an introduction to corporate EAP.” If the review committee can successfully establish that this rating definition has been satisfied for a predetermined amount of time (e.g., if the more particular steps outlined in FIG. 2 can be correctly completed), then the subject implementation activity should achieve a minimum rating of one (1). The review committee then considers the next highest rating definition (2)—“Employees provide input/feedback into EAP services (surveys, etc.)”. Following a similar determination process, the review committee determines if the second rating definition has been satisfied for a predetermined amount of time. This process proceeds up the incremental rating scale until a rating definition is not met. At that point, the review committee can determine that the highest possible rating for which the corresponding predefined rating definition previously was affirmatively satisfied is the one selected in step 14. Determined ratings may ultimately be presented in some readable format. Examples of such a readable format may include a spreadsheet, chart, table, or other visual aid that relays to others the results of the rating determination process.

Referring again to the process of FIG. 1, the ratings determined in selecting step 14 may optionally be entered into an automated database in step 24. Individual database entry may occur after rating determination for each implementation activity or selected groups of implementation activities is made or group entry may occur after all ratings are determined. Providing a database entry option may facilitate user-friendly interaction, especially since some known EAP evaluation systems are generally cumbersome and sometimes difficult to use. By providing an automated database that is accessible by multiple entities of a given corporate system, an effective and efficient way to access, analyze and use results of the subject evaluation process is afforded. An automated database may be accessible via a computerized network such as a local area network (LAN) at one or more given corporate facilities, an intranet established among multiple users or facilities within an entire corporation, or a globalized computer network such as the Internet. This type of accessibility would provide features to aid a corporation in comparing effectiveness levels of an interactive corporate system across multiple respective facilities and/or organizations.

One specific example of analysis afforded by providing the subject ratings in a networked database concerns providing rating results for a collection of different facilities within a given corporate system. For example, the following Table 6 provides data for seven different facilities and shows the number of facilities having a rating selected on a scale of zero (0) to six (6), respectively, for different implementation activities.

TABLE 6
Rating Chart for Seven (7) Different Facilities

| IMPLEMENTATION | | | | | | |
|---|---|---|---|---|---|---|
| ACTIVITY | NOT BASIC (0) | BASIC (1) | INTERMEDIATE (2) | COMMENDABLE (3) | SUPERIOR (4) | WORLD CLASS (5) |
| EAP Statement | 4 | 3 | | | | |
| EAP Service Providers | 3 | 3 | 1 | | | |
| EAP Committee | 4 | 3 | | | | |
| EAP Facility Objectives | 4 | 3 | | | | |
| Labor/Management Activities | 5 | 2 | | | | |
| Labor/Management Training | 7 | | | | | |
| EAP Operating | 6 | 1 | | | | |
| System Evaluation | | | | | | |
| Employee Roles & | 7 | | | | | |
| Responsibilities | | | | | | |
| EAP Awareness | 5 | 1 | 1 | | | |
| Promotion | 4 | 3 | | | | |
| Access | 3 | 3 | 1 | | | |
| Responsiveness | 4 | 1 | 2 | | | |
| Vendor Standards & | 5 | 1 | | 1 | | |
| Procedures | | | | | | |
| Vendor Credentials | 5 | | 1 | | | |
| Vendor Agreement | 5 | | 1 | 1 | | |

Referring once again to the exemplary process depicted in FIG. 1, additional steps may be effected to extend the subject measurement and evaluation of an interactive corporate system to a process that also addresses continual updating and improvement. For example, once ratings have been determined for the identified implementation activities, the results of those ratings may be utilized to identify in step 26 one or more of the implementation activities for which rating improvement is desired. Exemplary step 26 may also be performed by the established review committee or select members thereof. In one embodiment, the identification in step 26 selects only those areas that are most critical for advancement of the subject interactive corporate system. Setting priorities and identifying a limited number of areas to work on will help ensure adequate resources are available to take subsequent steps, such as may be effected in exemplary step 28 of FIG. 1.

In certain embodiments, the subject assessment process (and/or related updating and improvement steps) may be conducted periodically, such as every six (6), twelve (12), eighteen (18) or twenty-four (24) months, or as the need for evaluation is determined. In some embodiments, the subject evaluation technology can become a tool for continuous improvement with self assessments completed annually and new objectives established based on the results. Periodic reviews by resources external to a given corporate entity can be implemented to validate the provided implementation activities and provide an opportunity for benchmarking with other facilities.

It should be further appreciated that the subject evaluation and assessment technology may be supplemented by more particular guidance and support from various local and corporate resources, such as site-specific EAP vendors and an EAP committee. Identified directors or experts may provide consulting experience to help with the development of effective EAP systems and other interactive corporate systems, as well as to help solve specific problems, to address vendor issues, and to answer questions on program implementation, training, completing self-evaluations, surveys, forms and a variety of other related topics.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention.

1. A method for evaluating the performance of an interactive human resource system, said method comprising the following steps:
identifying a plurality of system implementation activities that concern system interaction from more than one input source;
providing a predefined rating definition for each of a plurality of possible ratings for each of said plurality of implementation activities; and
selecting one of said possible ratings for each of said plurality of implementation activities based on consideration of selected of the predefined rating definitions for each implementation activity; and
presenting said rating for selected of said implementation activities in a readable format.

2. The method of claim 1, wherein said plurality of implementation activities concern system interaction from a perspective of a vendor of said interactive human resource system, selected management personnel of the corporation utilizing said interactive human resource system, and selected employees who have interacted with said interactive human resource system.

3. The method of claim 1, further comprising the step of entering the selected rating for each of said implementation activities in a networked database accessible by multiple entities associated with said interactive human resource system.

4. The method of claim 1, wherein said possible ratings for each implementation activity are provided on incremental levels of potential system effectiveness and wherein said step of selecting one of said possible ratings for each of said plurality of implementation activities further comprises establishing that the predefined rating definition corresponding to said selected rating has been satisfied for a predetermined minimum amount of time.

5. The method of claim 4, wherein said step of establishing that the predefined rating definition corresponding to said selected rating for each implementation activity has been satisfied for a predetermined minimum amount of time further comprises at least one of the following steps:
determining what activities and tasks are being performed that demonstrate process steps are being implemented that meet the intent of the predefined rating definition;
identifying a responsible entity for the implementation activity;
determining how often aspects of the predefined rating definition corresponding to a given implementation activity are completed or updated; and
providing or locating documentation to support the selected rating and predefined definition for a given implementation activity.

6. The method of claim 1, further comprising the step of repeating said selecting step on a periodic basis to ensure updated ratings for each implementation activity are identified.

7. A method for evaluating the performance of an interactive employee assistance program, said method comprising the following steps:
identifying a plurality of system implementation activities for said interactive employee assistance program that address system interaction from more than one interactive entity;
providing a predefined rating definition for each of a plurality of possible ratings for each of said plurality of implementation activities; and
selecting one of said possible ratings for each of said plurality of implementation activities based on consideration of selected of the predefined rating definitions for each implementation activity; and
entering the selected rating for each of said implementation activities in a networked database accessible by multiple users associated with said employee assistance program.

8. The method of claim 7, wherein said plurality of implementation activities concern system interaction from a perspective of a vendor of said employee assistance program, selected management personnel of the corporation utilizing said employee assistance program, and selected employees who have interacted with said employee assistance program.

9. The method of claim 7, wherein said possible ratings for each implementation activity are provided on incremental levels of potential system effectiveness and wherein said step of selecting one of said possible ratings for each of said plurality of implementation activities further comprises establishing that the predefined rating definition corresponding to said selected rating has been satisfied for a predetermined minimum amount of time.

10. The method of claim 9, wherein said step of establishing that the predefined rating definition corresponding to said selected rating for each implementation activity has been satisfied for a predetermined minimum amount of time further comprises at least one of the following steps:
determining what activities and tasks are being performed that demonstrate process steps are being implemented that meet the intent of the predefined rating definition;
identifying a responsible entity for the implementation activity;
determining how often aspects of the predefined rating definition corresponding to a given implementation activity are completed or updated; and
providing or locating documentation to support the selected rating and predefined definition for a given implementation activity.

11. The method of claim 7, wherein said selecting step is repeated on a periodic basis to ensure updated ratings for each implementation activity are identified.

12. A method of evaluating and updating aspects of an interactive human resource system, said method comprising the following steps:
identifying a plurality of system implementation activities that concern system interaction from more than one interactive entity;
providing a predefined rating definition for each of a plurality of possible ratings for each of said plurality of implementation activities;
selecting one of said possible ratings for each of said plurality of implementation activities based on consideration of selected of the predefined rating definitions for each implementation activity;
identifying based on said selected ratings one or more of said implementation activities for which rating improvement is desired; and
taking subsequent steps within a given corporation to improve ratings of selected of the implementation activities identified for desired improvement.

13. The method of claim 12, wherein said plurality of implementation activities concern system interaction from a perspective of a vendor of said interactive human resource system, selected management personnel of the corporation utilizing said interactive human resource system, and selected employees who have interacted with the human resource system.

14. The method of claim 12, further comprising the step of entering the selected rating for each of said implementation activities in a networked database accessible by multiple entities associated said interactive human resource system.

15. The method of claim 12, wherein said possible ratings for each implementation activity are provided on incremental levels of determined effectiveness and wherein said step of selecting one of said possible ratings for each of said plurality of implementation activities further comprises establishing that the predefined rating definition corresponding to said selected rating has been satisfied for a predetermined minimum amount of time.

16. The method of claim 15, wherein said step of establishing that the predefined rating definition corresponding to said selected rating for each implementation activity has been satisfied for a predetermined minimum amount of time further comprises at least one of the following steps:
determining what activities and tasks are being performed that demonstrate process steps are being implemented that meet the intent of the predefined rating definition;
identifying a responsible entity for the implementation activity;
determining how often aspects of the predefined rating definition corresponding to a given implementation activity are completed or updated; and
providing or locating documentation to support the selected rating and predefined definition for a given implementation activity.

17. The method of claim 12, wherein said selecting step is repeated on a periodic basis to ensure updated ratings for each implementation activity are identified.

18. The method of claim 12, wherein said interactive human resource system comprises an employee assistance program.

19. The method of claim 12, further comprising the step of comparing one or more of the selected ratings to the ratings of corresponding implementation activities determined at different facilities within a given corporation.
